(19) United States
(12) Patent Application Publication
(10) Pub. No.: US 2021/0052999 A1
(43) Pub. Date: Feb. 25, 2021

(54) METHOD AND SYSTEM FOR MONITORING A FLUID SYSTEM CONFIGURED TO OPERATE WITH A FILTER

(71) Applicant: PRATT & WHITNEY CANADA CORP., Longueuil (CA)

(72) Inventors: Sorin NICULESCU, Richmond Hill (CA); Dana TOMESCU, Brampton (CA)

(21) Appl. No.: 16/546,920

(22) Filed: Aug. 21, 2019

(51) Int. Cl. B01D 35/143; G01M 15/14; G01L 13/00; B01D 35/00

(52) U.S. Cl. CPC B01D 35/143; B01D 35/005; G01L 13/00; G01M 15/14

(57) ABSTRACT

Systems and methods for monitoring a fluid system configured to operate with a filter are described herein. A differential pressure between an upstream position and a downstream position of a location of a filter is obtained. The differential pressure is compared to a differential pressure threshold. A maintenance action is detected when the differential pressure is below the differential pressure threshold and then a signal indicative that the maintenance action should be addressed is transmitted.

### TECHNICAL FIELD

The present disclosure relates generally to fluid system monitoring, and, more particularly, to methods and systems for monitoring a fluid system configured to operate with a filter.

### BACKGROUND OF THE ART

An engine is generally configured to operate with one or more filters. Each filter is used to filter a fluid, such as fuel, oil, hydraulic or air. The filter typically removes contaminants, such as impurities and/or residues, from the fluid. Once the filter gets clogged with contaminants, the fluid no longer passes through the filter. A bypass circuit can route the fluid around the filter when the filter is clogged. However, when the fluid with contaminants is allowed to flow into the engine, this may result in damage to the engine. Other fluid systems that operate with a filter may have similar problems.

As such, there is room for improvement.

### SUMMARY

In one aspect, there is provided a method for monitoring an engine configured to operate with a filter. The method comprises obtaining a differential pressure between an upstream position and a downstream position of a location of the filter, comparing the differential pressure to a differential pressure threshold, detecting a maintenance action when the differential pressure is below the differential pressure threshold and then transmitting a signal indicative that the maintenance action should be addressed.

In one aspect, there is provided a system for monitoring an engine configured to operate with a filter, the system comprises at least one processing unit and a non-transitory computer-readable memory having stored thereon program instructions. The program instructions are executable by the at least one processing unit for: obtaining a differential pressure between an upstream position and a downstream position of a location of the filter, comparing the differential pressure to a differential pressure threshold, detecting a maintenance action when the differential pressure is below the differential pressure threshold and then transmitting a signal indicative that the maintenance action should be addressed.

In one aspect, there is provided a method for monitoring a fluid system configured to operate with a filter. The method comprises obtaining a differential pressure between an upstream position and a downstream position of a location of the filter, comparing the differential pressure to a differential pressure threshold, detecting a maintenance action when the differential pressure is below the differential pressure threshold and then transmitting a signal indicative that the maintenance action should be addressed.

In one aspect, there is provided a system for monitoring a fluid system configured to operate with a filter, the system comprises at least one processing unit and a non-transitory computer-readable memory having stored thereon program instructions. The program instructions are executable by the at least one processing unit for: obtaining a differential pressure between an upstream position and a downstream position of a location of the filter, comparing the differential pressure to a differential pressure threshold, detecting a maintenance action when the differential pressure is below the differential pressure threshold and then transmitting a signal indicative that the maintenance action should be addressed.

### DESCRIPTION OF THE DRAWINGS

Reference is now made to the accompanying figures in which:

FIG. 1 is a schematic cross-sectional view of an example gas turbine engine, in accordance with one or more embodiments;

FIG. 2 is a schematic of an example fluid circuit of a fluid system, in accordance with one or more embodiments;

FIG. 3 is a flowchart illustrating an example method for monitoring a fluid system, in accordance with one or more embodiments;

FIG. 4 is an example computing device for implementing a method and/or system for monitoring a fluid system, in accordance with one or more embodiments.

It will be noted that throughout the appended drawings, like features are identified by like reference numerals.

### DETAILED DESCRIPTION

Systems and methods for monitoring a fluid system configured to operate with a filter are described herein. In some embodiments, the system and methods described herein are for monitoring an engine configure to operate with a filter.

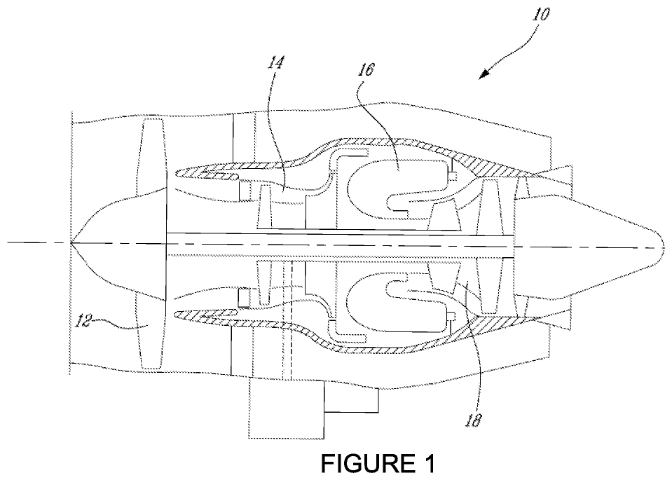

FIG. 1 illustrates a gas turbine engine 10 of a type that may be provided for use in flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. Note that while the gas turbine engine 10 illustrated in FIG. 1 is a turbofan engine, the methods and systems described herein may also be applicable to turboprop engines, turboshaft engines, other types of aircraft engines and any other suitable types of engines (e.g., industrial engines, automotive engines, etc.). Other examples of engines comprise auxiliary power units (APUs), rotary engines, and hybrid electric propulsion engines.

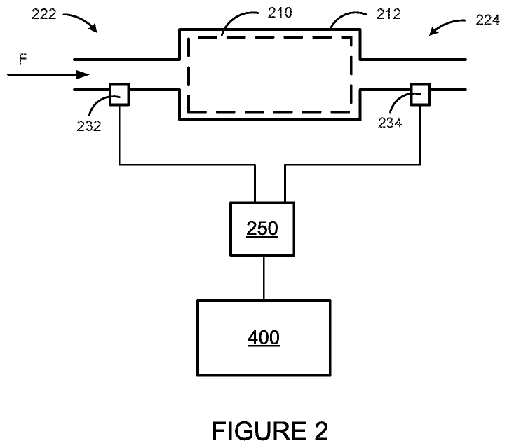

With reference to FIG. 2, a fluid circuit of a fluid system is shown. The fluid system may be any suitable system that is configured to operate with a filter for filtering a fluid that is to pass therethrough. In some embodiments, the fluid circuit is of an engine, such as engine 10. As illustrated, a filter 210 is to be positioned at a location 212 of the fluid system (e.g., a location of the engine 10). While FIG. 2 is described herein with reference to the engine 10, this is for example purposes only and the fluid circuit of FIG. 2 may be of any suitable fluid system. A fluid F flows through the location 212 and any filter 210 located at the location 212. As used herein, the terms “upstream” and “downstream” are defined relative to a normal flow direction of the fluid F. The fluid F may be fuel, a lubricant (e.g., oil), hydraulic, air or any other suitable fluid. Accordingly, the filter 210 may be a fuel filter, an oil filter, an air filter, a lubricant filter, a hydraulic filter, or any other suitable fluid filter. A differential pressure between an upstream position 222 and a downstream position 224 of the location 212 of the filter 210 can be obtained. In the embodiment illustrated in FIG. 2, the differential pressure is obtained by use of a differential pressure sensor 250 comprising a first sensor 232 at the upstream position 222 and a second sensor 234 at the downstream position 224. The first sensor 232 measures upstream pressure and the second sensor 234 measures downstream pressure. The differential pressure sensor 250 determines the differential pressure as a difference between the downstream pressure and the upstream pressure. The differential pressure sensor 250 provides the differential pressure to a computing device 400. When no filter is positioned at the location 212, the differential pressure is substantially equal to zero, as the downstream pressure is substantially equal to the upstream pressure. When a filter 210 is positioned at the location 212, the differential pressure generally increases with time as the filter 210 gets contaminated in time with impurities and/or residues. If the filter 210 ruptures, the differential pressure would decrease from its previous value prior to the filter rupture. The computing device 400 may accordingly monitor the differential pressure for the purposes of detecting a maintenance action when the differential pressure is below a differential pressure threshold. Detecting the maintenance action may comprise detecting that a missing filter is to be installed at the location 212, detecting that the filter 210 is ruptured and/or detecting any other suitable maintenance action.

In alternative embodiments, a first sensor 232 and a second sensor 234 provides the upstream pressure and the downstream pressure directly to the computing device 400 for determining the differential pressure and the differential pressure sensor 250 may be omitted. In some embodiments, the computing device 400 may be provided as part of the engine 10 or may be external to the engine 10. The differential pressure sensor 250 and/or the sensors 232, 234 may be provided as part of existing sensors provided by the engine 10 or may be added to the engine 10 for the purposes of obtaining the differential pressure. In other words, the sensors 250, 232, and/or 234 may be provided as part of the fluid system or may be external to the fluid system.

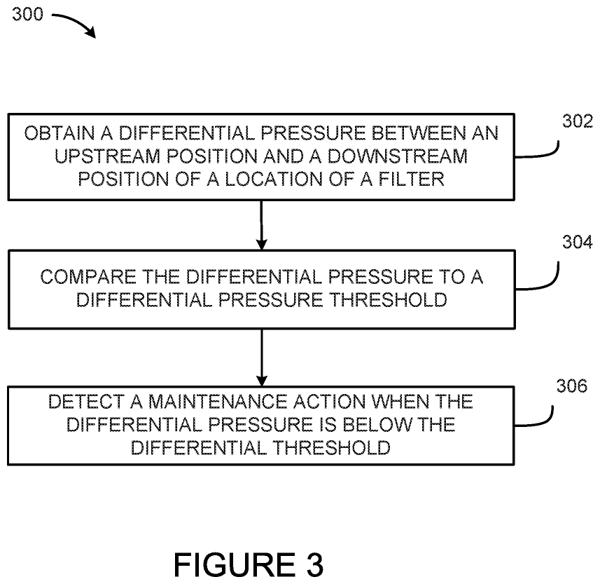

With reference to FIG. 3, there is shown a flowchart illustrating an example method 300 for monitoring a fluid system, such as of the engine 10 of FIG. 1. While the method 300 is described herein with reference to the engine 10 of FIG. 1, this is for example purposes only. The method 300 may be applied to any suitable engine and/or to any suitable fluid system configured to operate with a filter. The method 300 may be implemented by the computing device 400.

At step 302, a differential pressure between an upstream position 222 and a downstream position 224 of a location 212 of a filter 210 is obtained. In some embodiments, the differential pressure is obtained by receiving differential pressure measurements from a differential pressure sensor 250. The differential pressure sensor 250 may be an oil filter differential pressure sensor, a fuel filter differential pressure sensor, or any other suitable differential pressure sensor. The differential pressure sensor 250 may be located in the fuel system, oil system, or air system of the engine 10. The differential pressure sensor 250 may be a dual-channel pressure transducer. In some embodiments, the differential pressure is obtained by receiving an upstream pressure measurement at the upstream position 222 from a first sensor 232, receiving a downstream pressure measurement at the downstream position 224 from a second sensor 234, and determining the differential pressure as a difference between the downstream pressure measurement and the upstream pressure measurement. The first and second sensors 232, 234 may be fuel pressure sensors, oil pressure sensors, air pressure sensors or any other suitable sensors. In some embodiments, the differential pressure is obtained by receiving the differential pressure from an aircraft or engine computer. In some embodiments, the differential pressure is obtained by receiving the upstream pressure and the downstream pressure from an aircraft or engine computer and determining the differential pressure from the upstream pressure and the downstream pressure. The differential pressure (or the upstream pressure and the downstream pressure) may be obtained in real-time, near real-time, or whenever the differential pressure is needed and/or may be recorded in accordance with any suitable time interval or may be recorded irregularly.

At step 304, the differential pressure is compared to a differential pressure threshold. The differential pressure threshold may be predetermined or may be determine during the performance of the method 300. The comparison of the differential pressure to the differential pressure threshold may be performed in real-time for the purposes of monitoring the engine 10 in real-time while the engine 10 is operating.

At step 306, a maintenance action is detected when the differential pressure is below the differential pressure threshold. When the maintenance action is detected, a signal indicative that the maintenance action should be addressed is transmitted. For example, the signal may be transmitted to a display device to display an alert of the maintenance action or transmitted to a computer (e.g., an aircraft computer) communicatively coupled to a display device to cause the display device to display an alert of the maintenance action. This may allow for real-time monitoring of an aircraft engine while the aircraft is inflight. By way of another example, the signal may be transmitted to an on-ground computer in order to alert ground crew or other suitable person of the maintenance action. The term “on-ground computer” refers to a computer that is not on an aircraft that comprises the engine 10. The on-ground computer may be communicatively coupled to a display device to cause the display device to display an alert of the maintenance action. The alert may be a light or a text message in an aircraft cockpit or elsewhere on or off the aircraft. The alert may indicate the type of maintenance action (e.g., a ruptured filter needs to be replaced, a missing filter is to be installed, etc.). The signal may be transmitted to any other suitable electronic device or computer.

The method 300 may be for detecting when a filter is ruptured. Accordingly, in some embodiments, detecting the maintenance action at step 306 comprises detecting that the filter 210 is ruptured. A ruptured filter refers to a filter having a break, tear or hole that allows the fluid to pass through the break, tear or hole in the filter. The method 300 may further comprise determining the differential pressure threshold based on at least one previous differential pressure measurement between the upstream position 222 and the downstream position 224 of the location 212 of the filter 210. Accordingly, determining the differential pressure threshold may comprise setting the differential pressure threshold based on a highest recorded previous differential pressure measurement. The highest recorded previous differential pressure measurement may be obtained according to a rolling maximum of the obtained differential pressure at step 302. That is, the differential pressure obtained at step 302 may be recorded and/or tracked in real-time to determine the highest recorded previous differential pressure measurement.

The differential pressure threshold may be set at the highest recorded previous differential pressure measurement minus an offset. The offset may be a predetermined value or may be determined during the performance of the method 300. For example, the offset may be set at a percentage or other function of the highest recorded previous differential pressure measurement. The offset may be set based on an expected decrease in pressure when a filter rupture occurs. The expected decrease in pressure may be determined by recording the differential pressure when a filter rupture occurs. The expected decrease in pressure may correspond to an average of a plurality of differential pressure measurements of a rupture of one or more filters. The offset would typically be set such that it would be larger than differential pressure variations in normal operation of the engine 10.

In some embodiments where the fluid is oil, and a chip detector may be used to confirm filter rupture by way of correlation, as a ruptured filter would create more contamination in the oil system and the chip detector may indicate higher contamination. However, depending on the size of the filter hole when it is ruptured, there may be insufficient contamination to trigger the chip detector and thus absence of chip detector indication is not necessarily indicative of absence of filter rupture.

It should be appreciated that by monitoring the fluid system to detect when the filter 210 is ruptured may allow for early failure detection of the filter 210 and/or may allow for the service life of the filter 210 to be extended.

The method 300 may be for detecting when a filter is missing. A missing filter refers to no filter being installed at the location 212 for the filter. Accordingly, in some embodiments, detecting the maintenance action at step 306 comprises detecting that a missing filter is to be installed at the location 212 for the filter. In some embodiments, the differential pressure threshold is predetermined based on an expected differential pressure of a new filter. The expected differential pressure of the new filter may be determine by recording the differential pressure when a new filter is installed in the location 212. The expected differential pressure of the new filter may correspond to an average of a plurality of differential pressure measurements of one or more new filters.

In some embodiments, the method 300 further comprises starting a timer when the differential pressure drops below the differential pressure threshold and detecting the maintenance action when the timer exceeds a predetermined period of time. The timer would be reset if the differential pressure exceeds the differential pressure threshold before the timer exceeds the predetermined period of time.

During engine transient conditions, the fluid pressure (e.g., oil pressure or fuel pressure) may increase or decrease. Accordingly, the methods and systems described herein may be able to differentiate between the effect of a commanded set point and the change in pressure due to contamination or rupture of the filter 210. In some embodiments, the method 300 comprises detecting when the engine 10 is operating in a transient condition and correcting the differential pressure obtained at step 302. The differential pressure may be corrected based on one or more engine operating parameters. The engine operating parameter(s) may comprise one or more of: engine speed (e.g. N2 speed); pressure (e.g., main oil pressure (MOP)); temperature (e.g., main oil temperature (MOT)); and any other suitable parameter(s). The parameter(s) selected may be sampled such that each parameter is indicative of a steady state for that parameter, rather than a transient value, which may not be representative of that parameter's true value.

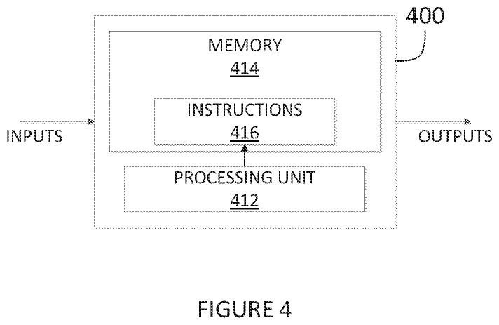

With reference to FIG. 4, the method 300 may be implemented using a computing device 400 comprising a processing unit 412 and a memory 414 which has stored therein computer-executable instructions 416. The processing unit 412 may comprise any suitable devices configured to implement the system such that instructions 416, when executed by the computing device 400 or other programmable apparatus, may cause the functions/acts/steps of the method 300 as described herein to be executed. The processing unit 412 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 414 may comprise any suitable known or other machine-readable storage medium. The memory 414 may comprise non-transitory computer readable storage medium, for example, but not limited to, an electronic, magnetic, optical, electromagnetic, infrared, or semiconductor system, apparatus, or device, or any suitable combination of the foregoing. The memory 414 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 414 may comprise any storage means (e.g., devices) suitable for retrievably storing machine-readable instructions 416 executable by processing unit 412. In some embodiments, the computing device 400 can be implemented as part of a full-authority digital engine controls (FADEC) or other similar device, including electronic engine control (EEC), engine control unit (ECU), and the like.

The methods and systems for monitoring a fluid system described herein may be implemented in a high level procedural or object oriented programming or scripting language, or a combination thereof, to communicate with or assist in the operation of a computer system, for example the computing device 400. Alternatively, the methods and systems for monitoring a fluid system may be implemented in assembly or machine language. The language may be a compiled or interpreted language. Program code for implementing the methods and systems for monitoring a fluid system may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for monitoring a fluid system may also be considered to be implemented by way of a non-transitory computer-readable storage medium having a computer program stored thereon. The computer program may comprise computer-readable instructions which cause a computer, or in some embodiments the processing unit 412 of the computing device 400, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the methods and systems for monitoring a fluid system may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

What is claimed is:

1. A method for monitoring an engine configured to operate with a filter, the method comprising:
obtaining a differential pressure between an upstream position and a downstream position of a location of the filter;
comparing the differential pressure to a differential pressure threshold;
detecting a maintenance action when the differential pressure is below the differential pressure threshold and then transmitting a signal indicative that the maintenance action should be addressed.

2. The method of claim 1, wherein detecting the maintenance action comprises detecting that the filter is ruptured.

3. The method of claim 2, further comprising determining the differential pressure threshold based on at least one previous differential pressure between the upstream position and the downstream position of the location of the filter.

4. The method of claim 3, wherein determining the differential pressure threshold comprises setting the differential pressure threshold based on a highest recorded previous differential pressure.

5. The method of claim 1, wherein detecting the maintenance action comprises detecting that a missing filter is to be installed at the location for the filter.

6. The method of claim 5, wherein the differential pressure threshold is predetermined based on an expected differential pressure of a new filter.

7. The method of claim 6, wherein the expected differential pressure of the new filter corresponds to an average of a plurality of differential pressure measurements of one or more new filters.

8. The method of claim 1, further comprising starting a timer when the differential pressure drops below the differential pressure threshold and detecting the maintenance action when the timer exceeds a predetermined period of time.

9. The method of claim 1, wherein obtaining the differential pressure comprises receiving differential pressure measurements from a differential pressure sensor.

10. The method of claim 1, wherein the filter is an oil filter or a fuel filter.

11. A system for monitoring an engine configured to operate with a filter, the system comprising:
a processing unit; and
a non-transitory memory communicatively coupled to the processing unit and comprising computer-readable program instructions executable by the processing unit for:
obtaining a differential pressure between an upstream position and a downstream position of a location of the filter;
comparing the differential pressure to a differential pressure threshold;
detecting a maintenance action when the differential pressure is below the differential pressure threshold and then transmitting a signal indicative that the maintenance action should be addressed.

12. The system of claim 11, wherein detecting the maintenance action comprises detecting that the filter is ruptured.

13. The system of claim 12, wherein the computer-readable program instructions are further executable by the processing unit for determining the differential pressure threshold based on at least one previous differential pressure between the upstream position and the downstream position of the location of the filter.

14. The system of claim 13, wherein determining the differential pressure threshold comprises setting the differential pressure threshold based on a highest recorded previous differential pressure.

15. The system of claim 11, wherein detecting the maintenance action comprises detecting that a missing filter is to be installed at the location for the filter.

16. The system of claim 15, wherein the differential pressure threshold is predetermined based on an expected differential pressure of a new filter.

17. The system of claim 16, wherein the expected differential pressure of the new filter corresponds to an average of a plurality of differential pressure measurements of one or more new filters.

18. The system of claim 11, wherein the computer-readable program instructions are further executable by the processing unit for starting a timer when the differential pressure drops below the differential pressure threshold and detecting the maintenance action when the timer exceeds a predetermined period of time.

19. The system of claim 11, wherein obtaining the differential pressure comprises receiving differential pressure measurements from a differential pressure sensor.

20. A method for monitoring a fluid system configured to operate with a filter, the method comprising:
obtaining a differential pressure between an upstream position and a downstream position of a location of the filter;
comparing the differential pressure to a differential pressure threshold;
detecting a maintenance action when the differential pressure is below the differential pressure threshold and then transmitting a signal indicative that the maintenance action should be addressed.
